(19) United States
(12) Patent Application Publication
(10) Pub. No.: US 2013/0093419 A1
(43) Pub. Date: Apr. 18, 2013

(54) METHOD AND APPARATUS FOR DETERMINING THERMAL MAGNETIC PROPERTIES OF MAGNETIC MEDIA

(71) Applicants: Chengwu An, Singapore (SG); Kaidong Ye, Singapore (SG); Qiong Xie, Singapore (SG); Wendong Song, Singapore (SG); Kay Siang Tiaw, Singapore (SG)

(72) Inventors: Chengwu An, Singapore (SG); Kaidong Ye, Singapore (SG); Qiong Xie, Singapore (SG); Wendong Song, Singapore (SG); Kay Siang Tiaw, Singapore (SG)

(73) Assignee: AGENCY FOR SCIENCE, TECHNOLOGY AND RESEARCH, Singapore (SG)

(21) Appl. No.: 13/703,557

(22) PCT Filed: Jun. 13, 2011
(86) PCT No.: PCT/SG11/00209

§ 371 Date: Dec. 11, 2012

Related U.S. Application Data
(60) Provisional application No. 61/353,902, filed on Jun. 11, 2010.

(51) Int. Cl. G01N 21/01; G01N 21/63

(52) U.S. Cl. CPC G01N 21/01; G01N 21/63
USPC 324/244.1

(57) ABSTRACT

An apparatus and method of testing a magnetic medium at temperatures of interest is disclosed. Properties of the magnetic medium are determined by focusing light from a source of polarized light on a magnetic surface of the magnetic medium; measuring polarization of resulting reflected light due to the magneto-optical Kerr effect, using, for example a measuring subsystem; and varying the light source to heat the magnetic material where incident to pre-defined temperatures, thereby allowing determination of the magnetic properties using the magneto-optical Kerr effect at said pre-defined temperatures.

### CROSS-REFERENCE TO RELATED APPLICATIONS

This application claims priority from U.S. Provisional Application No. 61/353,902 entitled, “METHOD AND APPARATUS FOR THERMAL MAGNETIC PROPERTIES OF MAGNETIC MEDIA” and filed Jun. 11, 2010, the contents of which are hereby incorporated by reference.

### FIELD OF THE INVENTION

The present invention relates generally to magnetic materials, and more particularly to methods and devices for measurement of thermal magnetic properties of magnetic media at different temperature using Magneto-Optical Kerr Effect (MOKE).

### BACKGROUND OF THE INVENTION

The performance of magnetic storage media depends largely upon magnetic properties of the recording layer. Important properties include coercivity and remanance of the material.

The coercivity (typically expressed in Oersteds) is the minimum magnetic intensity of an applied magnetic field sufficient to cause the magnetic media to undergo a transition from a state of magnetic saturation to a non-magnetized state. The remanance (typically expressed in Ampere/M) indicates magnetization left behind in a sample after an external magnetic field is removed and thus relates to strength of electrical signal recoverable from a magnetic-electrical transfer.

There are several approaches to testing magnetic media for their magnetic properties: one includes the use of a Vibrating Sample Magnetometer (VSM), another uses a Superconducting Quantum Interference Device, yet another makes use of a Magneto-Optical Kerr Effect (MOKE) system.

The MOKE is the phenomenon that light reflected from a magnetized material has a slightly rotated plane of polarization. The degree of polarization depends on the magnetic properties of the material and the applied magnetic field.

A typical MOKE system includes a single laser source configured to provide a probing beam to detect Kerr signal dependence on an applied magnetic field at room temperature only. A hysteresis loop of a magnetic media is then plotted to obtain its magnetic properties. To measure the magnetic properties at elevated temperature, such as for the research of the magnetic media for heat assisted magnetic recording, a sample is cut and heated to a required temperature before measurement. This method is time-consuming and is also destructive in that it requires the cutting a magnetic medium and a well designed heating unit.

Therefore, there is a need for a MOKE system that can perform measurement of thermal magnetic properties of magnetic media at different temperature without an additional heating unit and without destroying the magnetic media.

### SUMMARY OF THE INVENTION

In accordance with an aspect of the present invention, an apparatus for testing a magnetic medium at multiple temperatures of interest, comprises a light source to provide polarized light incident on a magnetic surface of the magnetic medium; a measuring subsystem to measure polarization of reflected light due to the magneto-optical Kerr effect, the reflected light reflected from the magnetic medium in response to the polarized light incident on the magnetic surface. As such, the polarized light heats the magnetic surface where the polarized light is incident, to the multiple temperatures of interest, to allow determination of magnetic properties of the magnetic medium at the multiple temperatures of interest using the magneto-optical Kerr effect.

In accordance with another aspect of the present invention, a method of testing a magnetic medium at temperatures of interest, the method comprises focusing light from a source of polarized light to be incident on a magnetic surface of the magnetic medium; measuring polarization of reflected light due to the magneto-optical Kerr effect, the reflected light reflected from the magnetic medium as a result of the light where incident; and varying the light source to heat the magnetic material where incident to pre-defined temperatures, to allow determination of the magnetic properties of the magnetic medium using the magneto-optical Kerr effect at the pre-defined temperatures.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1A is a schematic diagram of a MOKE system with a single laser source use to both probe and heat, exemplary of an embodiment of the present invention;

FIGS. 1B and 1C are schematic diagrams of the system of FIG. 1A, in operation;

FIG. 1D is a schematic diagram of the MOKE system of FIG. 1A, further including a temperature calibration subsystem;

FIG. 2 is a schematic diagram of a further MOKE system exemplary of an embodiment of the present invention;

FIG. 3 is a schematic diagram showing the adjustment of incident laser power exemplary of an embodiment of the present invention;

FIG. 4 is a flow chart showing a method for measurement of thermal magnetic properties of a magnetic medium at pre-determined temperatures in accordance with an embodiment of the present invention;

FIG. 5 is a schematic diagram showing a method for calibrating temperature with laser power according to an embodiment of the present invention;

FIG. 6 is a schematic diagram showing the infra-red sensor used to monitor surface temperature of a magnetic media, in accordance with an embodiment of the present invention; and

FIGS. 7A-7F are graphs showing hysteresis loops of a magnetic medium under different temperatures, measured in accordance with an embodiment of the present invention.

### DETAILED DESCRIPTION

Exemplary of embodiments of the present invention, an apparatus for measuring thermal magnetic properties of magnetic media at different temperatures uses the Magneto-Optical Kerr Effect (MOKE). Embodiments of the present invention advantageously may use only one laser beam to both heat a measured medium and probe the Kerr signal.

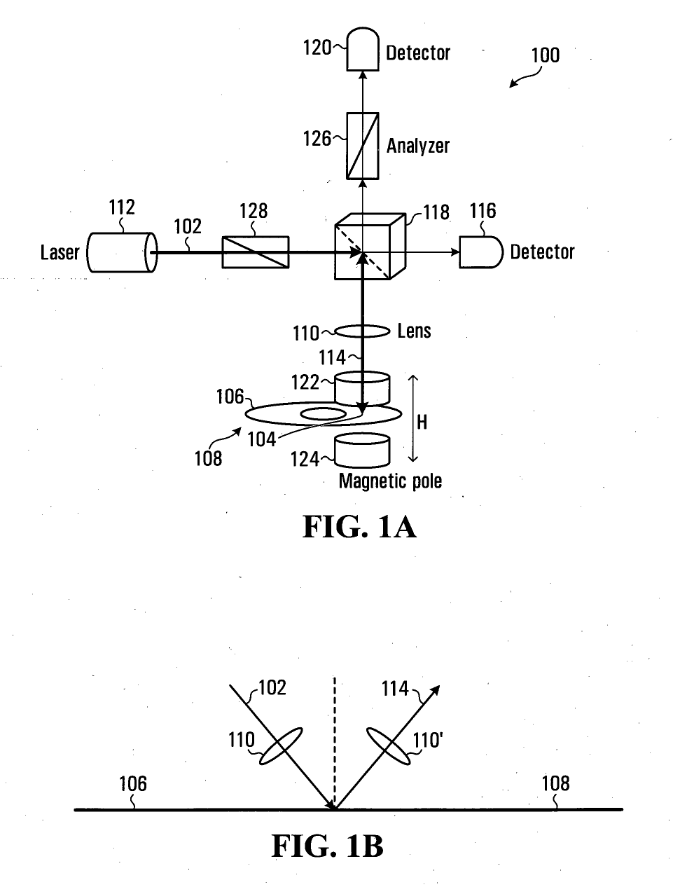

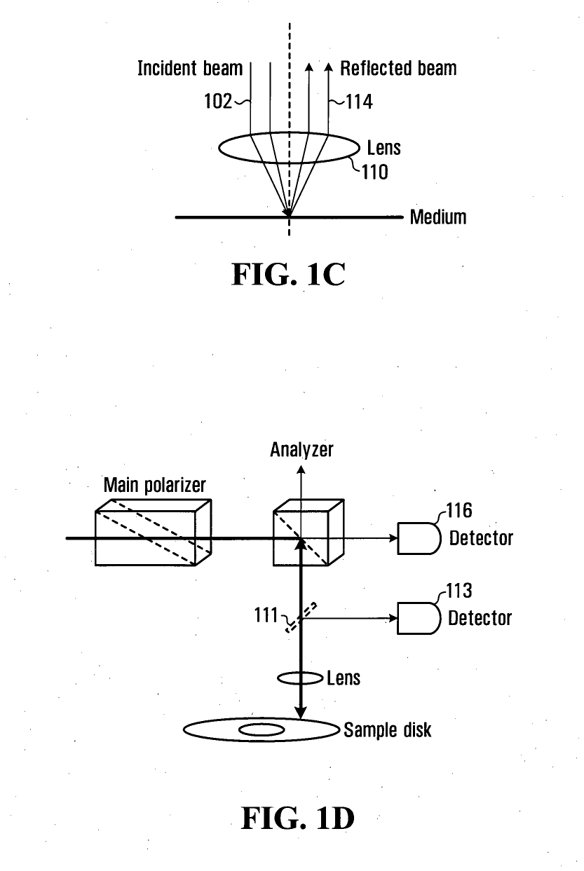

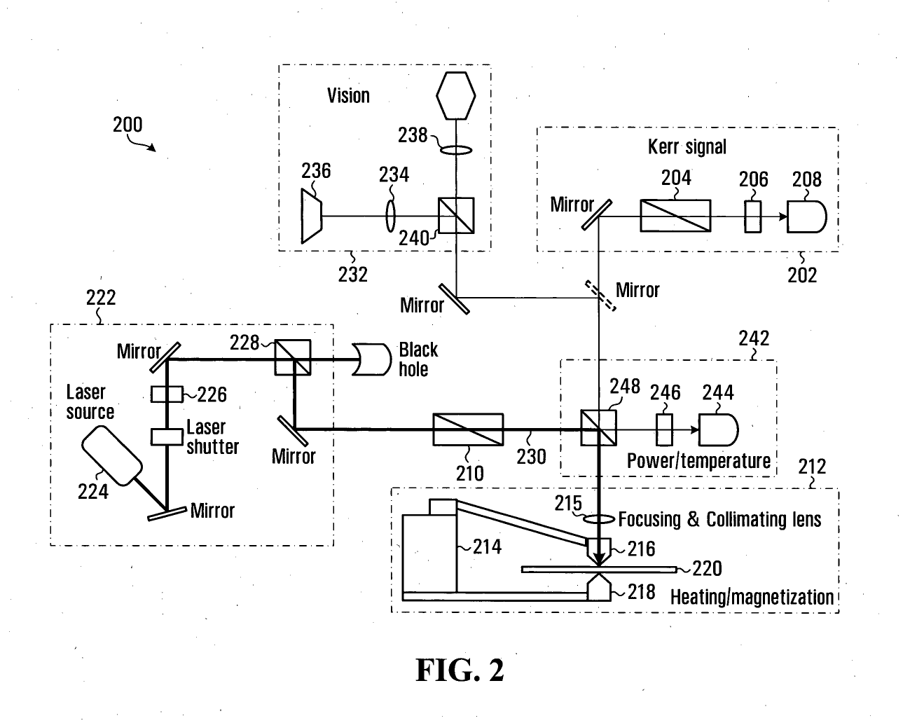

FIGS. 1A and 2 are schematic diagrams of MOKE systems exemplary of embodiments of the present invention. A single laser source (112, 222) provides a laser beam (102, 230), which functions as both a heating source and as a probing signal. Therefore, an additional heating source is not required.

Conveniently, laser source (112, 222) running with an output of linear polarization beam of 200 milli-wattage (mW) may be used. The power incident to a measured medium may be adjusted in the range of 0.1-200 mW with an external adjustment unit for heating the medium to a temperature from room temperature to 700 K. If a higher temperature is desired, it can be realized by focusing the laser beam more tightly. This power level is higher than the laser power (several mW to tens of mW) used in a typical MOKE system.

Laser source 122, 222 may conveniently be a continuous wave laser. Conveniently, with a continuous wave laser, synchronization with data acquisition is not required and implementation is simplified and more cost effective. Alternatively, a pulsed laser may be used as source 122, 222, and data acquisition may be synchronized with each laser pulse.

Different temperatures can be achieved on the surface of the magnetic media by fine-tuning the incident laser power. Since the Kerr rotation angle is calculated using ratio of detected intensity, a change in incident laser power will not affect the Kerr effect. A plot of the Kerr signal against applied magnetic field forms a hysteresis loop of the magnetic media at the heated temperature. This hysteresis loop determines the magnetic properties of the magnetic media at such temperature.

As will become apparent, the surface of the magnetic media may be heated to multiple temperatures of interest—for example between 293 K to 700 K, ranging from about room temperature to the Curie temperature of the media.

In an embodiment, there is provided an apparatus 100 for measurement of thermal magnetic properties of magnetic media at different temperatures using Magneto-Optical Kerr Effect (MOKE), as schematically depicted in FIG. 1A. Apparatus 100 may include a laser focusing and collimating arrangement configured to focus energy of an incident optical beam 102 from a laser source 112 towards a small focused spot 104 at a surface 106 of a magnetic medium 108.

Laser light from source 112 is passed through a polarizer 128, and a polarizing beam splitter 118. Polarized light is directed by polarizing beam splitter 118 to lens 110. A focused laser beam may be realized with a focusing lens 110 and a collimating laser beam may also be realized with the same focusing lens 110. Lens 110 thus may play roles both in focusing the laser beam and collimating the beam. With the arrangement, the incident optical beam 102 is focused to high intensity by focusing lens 110 so that the small spot 104 on the surface 106 of magnetic medium 108 is heated to a predetermined temperature, even though the power of the laser source 112 may be of similar range as that of a conventional MOKE system. Only a small fraction of the laser beam passes through splitter 118 and is received by detector 116, which records the records laser power, and may be used for temperature calibration. Conveniently, the heated point is exactly the same point as a measurement point. A magnetic field may be applied to magnetic medium 108 by poles 122 and 124. The magnetic field may be time varying.

As temperature will be dependent on the power of the applied beam 102, and duration of application, a function correlating the times of application for a particular laser source 102/magnetice medium 108 with temperature of the medium may be determined experimentally.

The reflected optical beam 114 from surface 106 of magnetic medium 108 is reflected toward polarizing beam splitter 118 after having been collimated by collimating lens 110 to a parallel beam and then towards an analyzer 126. Now, as will be appreciated, as a result of the MOKE, the polarization of reflected light will be changed—a so-called Kerr rotation will occur in the reflected beam. A light component belonging to Kerr signal in the reflected optical beam 114 from the surface 106 of the magnetic medium 108 is allowed to almost fully pass through a polarizing beam splitter 118 and enter analyzer 126 while a light component with original polarization determined by a main polarizer 128 in reflected beam 114 is mostly reflected in the direction of laser source 112 by polarizing beam splitter 118.

The incident optical beam 102 may be incident substantially vertically on surface 106 of magnetic medium 108. The reflected optical beam 114 from surface 106 of magnetic medium 108 is collimated to a parallel beam again by focusing lens 110 and then split by a polarizing cube beam splitter 118 (FIG. 1A). As noted, the Kerr signal component of the reflected optical beam 114 passes through polarizing beam splitter 118 to analyzer 126. At analyzer 126 the so-called Kerr signal reaches a detector 120, which may record signal intensity change when the magnetic field intensity varies.

The laser power may be monitored with a detector 116. By reading the detector 116, the temperature of the medium heated may be calibrated.

Detectors 116 and 120 may be in communication with, or part of a computing device (not shown) programmed to record the Kerr signal intensities/magnetic field intensity at various temperatures. Likewise, laser 112 and magnetic poles 122 and 124 may be in communication with, and controlled by the computing device (not specifically illustrated). The computing device may, for example, cause the magnetic field between magnetic poles 122 and 124 to sweep from a positive maximum value to a negative value, and back.

The recorded Kerr signal- magnetic field intensity dependence will form a hysteresis loop if the magnetic field is swept at enough intensive amplitude from positive to negative and then back to positive. The part with original polarization in the reflected optical beam is mostly reflected back by the polarizing beam splitter 118. Conveniently, vertical incidence of optical beam 102 allows only one lens 110 to be used for both focusing and collimating a laser beam. This makes system easier to implement because of very limited space around magnetic poles 122,124.

To avoid some resonance resulting from co-axis reflection, a small angle between the incident beam and the normal of medium surface may be used, as depicted in FIG. 1C. The angle may be adjusted to ensure that the incident optical beam 102 is located on one side of the optical axis of lens 110 and the reflected optical beam 114 is located on the other side of the axis. As will be appreciated, the reflected optical beam 114 need also not travel the same path as the incident optical beam 102. The incident optical beam 102 may, for example, be incident at an angle on the surface 106 of the magnetic medium 108, as exemplified in FIG. 1B, to ensure that the incident beam 102 and reflected optical beam 118 take different paths. In this case, a pair of lenses may be used: focusing lens 110 is on the path of incident beam, and a further collimating lens 110′ may be inserted in the path of reflective beam.

Optionally, as illustrated in FIG. 1D, apparatus 100 may further include a detector 113 that may measure the intensity of the reflected beam (sampled by a sampler or partial mirror 111). The ratio of signal at detector 113 to that at detector 116 may evidence the reflectivity of surface 106. As will be appreciated, as the temperature increases, the reflectivity of surface 106 will decrease. Reflectivity may therefore be used to calibrate the temperature of sample 106. As required, temperature as a function of reflectivity T=f(R) may be experimentally determined.

In an alternate embodiment depicted in FIG. 2, an apparatus 200 for measurement of thermal magnetic properties of magnetic media 220 at different temperatures using MOKE may further include a signal detection arrangement 202 configured to monitor the Kerr signal resulting from an incident optical beam when a magnetic field is applied at a temperature heated on the spot on the surface of the magnetic medium.

As in the embodiment of FIG. 1, a laser source 222 provides a laser beam 230 to be focused on magnetic material 220. Laser beam 230 is passed through main polarizer 210 and beam splitting polarizer 248 to arrive at magnetic material 220, where a small fraction of the beam may be passed to detector 244, to monitor laser power and for temperature calibration. Again, the beam may be focused by lens 215. Reflected light from material 220 will be optically polarized as a consequence of the magneto-optical Kerr effect. Reflected light will pass to beam splitter 248, where a component is directed to detector 244 of detection arrangement 242 and detector 208 of detection arrangement 202. Beam 230 thus again heats and probes magnetic material 220.

Signal detection arrangement 202 may include an analyzer 204, a laser light filter 206 and a photo-detector 208. Analyzer 204 may take the form of an optical polarizer, configured almost vertically to main polarizer 210 in optical axis, to allow the Kerr signal component in the optical beam to almost fully pass through and the component with original polarization in the optical beam to be mostly blocked. Laser light filter 206 blocks light from other sources. The signal received by photo-detector 208 is thus the Kerr signal resulting from the magnetic field applied to the magnetic material 220. The Kerr signal against the applied magnetic field plots a hysteresis loop of the magnetic medium at the temperature heated, then at least one magnetic property of the magnetic medium can be determined from the hysteresis loop. A general purpose computing device (not shown), in the form of a personal computer, controller, or other data processing apparatus, under software control may control the overall operation of apparatus 200, and may be in communication with signal detection arrangement. 202 for recording of the magnitude of the Kerr signal component at various temperatures, and in the presence of applied magnetic fields. Likewise the general purpose computing device may again monitor the temperature of magnetic material 220.

Optionally apparatus 200 may also include a magnetic field generation arrangement 212 configured to apply a magnetic field of a time-varying strength to a portion of the magnetic medium. Magnetic field generation arrangement 212 includes a magnetic field driver (not shown), a magnetic coil 214, magnetic poles 216, 218 and an optional magnetic field meter (not shown). Magnetic field generation arrangement 212 is used to generate a magnetic field that is applied to a region of a magnetic medium 220, where measurement is taken. The strength, orientation and sweep duration of the magnetic field are determined by the magnetic field driver, and may for example be controlled by the above described computing device.

Optionally, apparatus 200 may further include a light source 222 having a laser source 224 and an external laser power adjustment unit comprising a half wave plate 226 and a polarizing beam splitter 228. A main polarizer 210 for generating pure linear polarizing beam to probe Kerr effect is configured to direct a polarized optical beam 230 towards the portion of magnetic medium 220 that is in the magnetic field, wherein the optical beam is reflected by the surface of magnetic medium 220 at a point of incidence in the magnetic field.

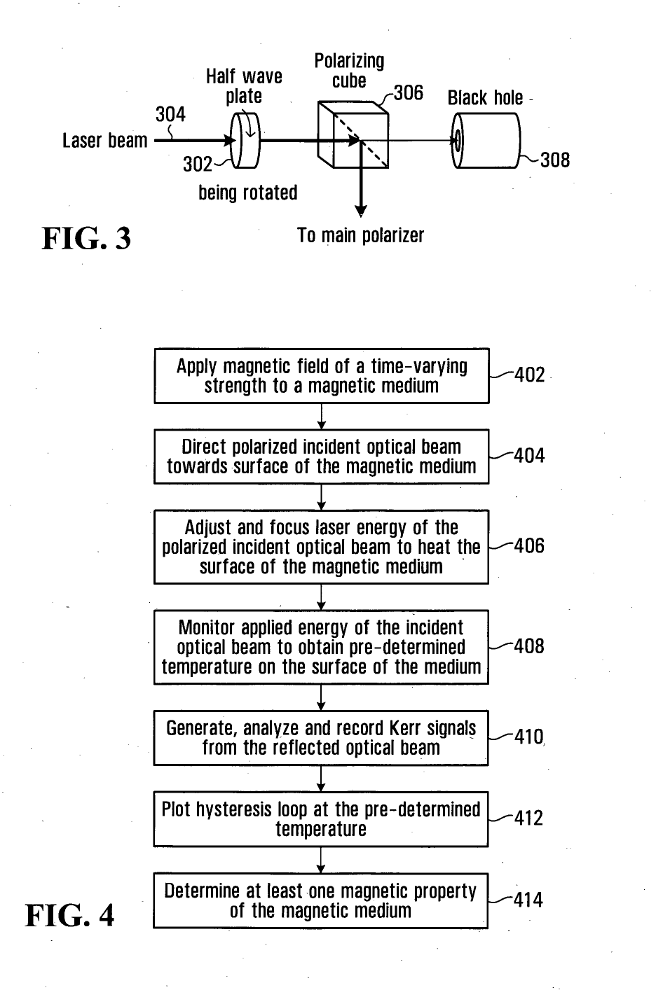

Laser power adjustment may be realized by a pair of a half wave plate 302 and polarizing beam splitter 306 if the laser beam is of a linear polarization, as shown in FIG. 3.

Half wave plate 302 may be rotated manually or by motor (not shown). As a consequence, the laser power 304 delivered to main polarizer 210 direction through polarizing beam splitter 306 will be changed accordingly. In this way, laser power and/or intensity of the incident polarized light is adjusted very conveniently. A black hole 308 is used to collect unused laser power. Once again, half wave plate 302 and light source 222 may be in communication with, and controlled by, the computing controlling overall operation of apparatus 200.

Optionally, apparatus 200 may further include a vision unit 232 configured to check the optical beam focusing status. The vision arrangement includes an imaging lens 234, a CCD camera 236, a lighting source 238, and a beam splitter 240. The vision unit is used to monitor the focusing status of the laser beam at the surface of the magnetic medium 220, and to find a measurement spot on the magnetic medium if it is necessary. Again, the vision unit 234 may be in communication with the computing controlling overall operation of apparatus 200.

In alternate embodiments, the duration, intensity or frequency of the laser source 224 may be varied to heat the surface of the magnetic medium to multiple temperatures of interest.

Also, apparatus 200 may optionally further include a laser power and temperature monitoring arrangement 242. Laser power used to heat magnetic medium 220 is monitored with a photodiode 244, combining with a laser line filter 246, which blocks light from other source. Polarized laser beam 230 is directed to the polarizing beam splitter 248, where most of the laser power is guided to the surface of the magnetic medium 220 for heating and probing, and only a very small part of the laser power goes through the polarizing beam splitter 248 and into photodiode 244. Using the laser power recorded, a temperature of the magnetic medium 220 heated at the laser spot can be calibrated.

Examples of magnetic properties that may be determined using apparatus 200 or 100, include but are not limited to, are coecivity (Hₑ), nuclei field (Hₐ), saturation field (Hₛ), remanence (Mᵣ), and saturation remanence (Mₛ).

The above presented embodiments are configured for use with magnetic media for perpendicular recording. Embodiments of the present invention may be advantageously adopted for use with perpendicular recording media. However, embodiments of the present invention may be applicable to use with longitudinal recording media.

As illustrated in FIG. 4, the method includes applying a magnetic field of a time-varying strength (using, for example poles 122, 124—FIG. 1A) to a portion of the magnetic medium in block 402. The method may further include directing a polarized incident optical beam (e.g. beam 102) towards a surface of the magnetic medium (e.g. medium 106) that is in the magnetic field, wherein the optical beam is reflected by the surface of the magnetic medium at a point of incidence in the magnetic field in block 404. The method may further include adjusting and focusing the energy of an incident optical beam (e.g. using lens 110) towards a small spot at the surface of the magnetic medium, wherein the surface of the magnetic medium is heated to one or more pre-determined temperature of interest in block 406. The method may further include monitoring the applied energy of the incident optical beam (e.g. using detector 113), by which the temperature of the magnetic medium at the optical spot may be calibrated in block 408. The method may further include generating, analyzing and recording a series of Kerr signal from the reflected optical beam of the magnetic medium in block 410 (e.g. using detector 120). The method may further include plotting hysteresis loop of the magnetic medium at the pre-determined temperature in block 412 where at least one magnetic property of the magnetic medium from the hysteresis loop may be determined in block 414, using an interconnected computing device. Of course, the above mentioned method may not necessarily be carried out in the order as presented.

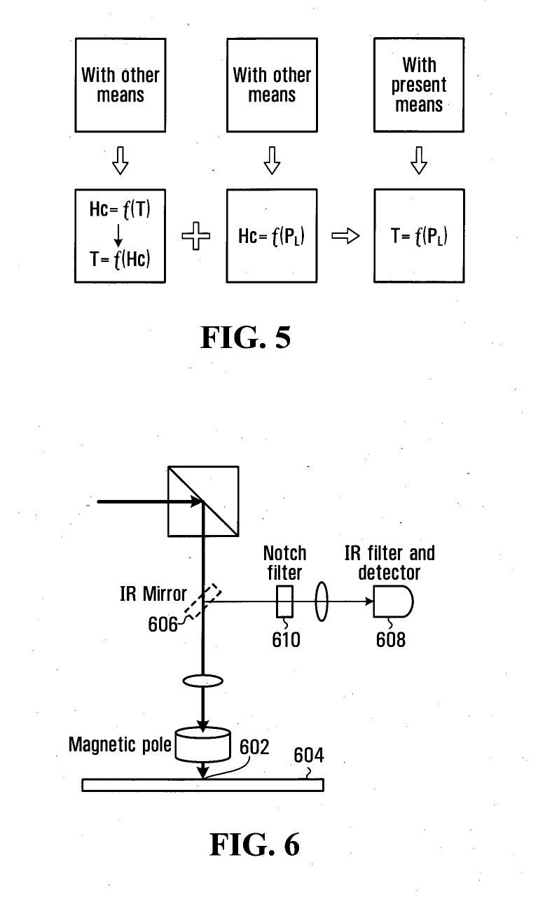

An example of the temperature calibration mentioned above can be illustrated using the schematic diagram shown in FIG. 5. A magnetic medium is cut into two parts. The first part is measured with a suitable measuring apparatus, such as Vibrating Sample Magnetometer (VSM), to get its coercivity dependence on temperature. Reversing the relationship, a temperature dependence on coercivity of the magnetic medium is obtained, namely an expression of temperature-coercivity T=f(H_{c}) is obtained. Then the second part of the magnetic medium is measured in manners exemplary of the present invention. A coercivity dependence on laser power, namely an expression of coercivity—laser power H_{c}=f(P_{L}) is obtained. Using the temperature-coercivity expression and the coercivity—laser power expression, a temperature—laser power expression T=f(P_{L}) is obtained. Therefore, the calibration of temperature with laser power is complete.

As an alternative, the temperature of the medium can also be monitored with measurement of near infra-red (NIR) radiation from the spot heated 602 of the surface of the magnetic medium 604, as shown in FIG. 6. The NIR radiation is directed with an infra-red (IR) mirror 606 to an IR detector 608, that acts as a temperature sensor, before which a laser line notch filter 610 with IR pass through is used to block laser line. In this way the temperature can be calibrated with the intensity of the IR irradiation.

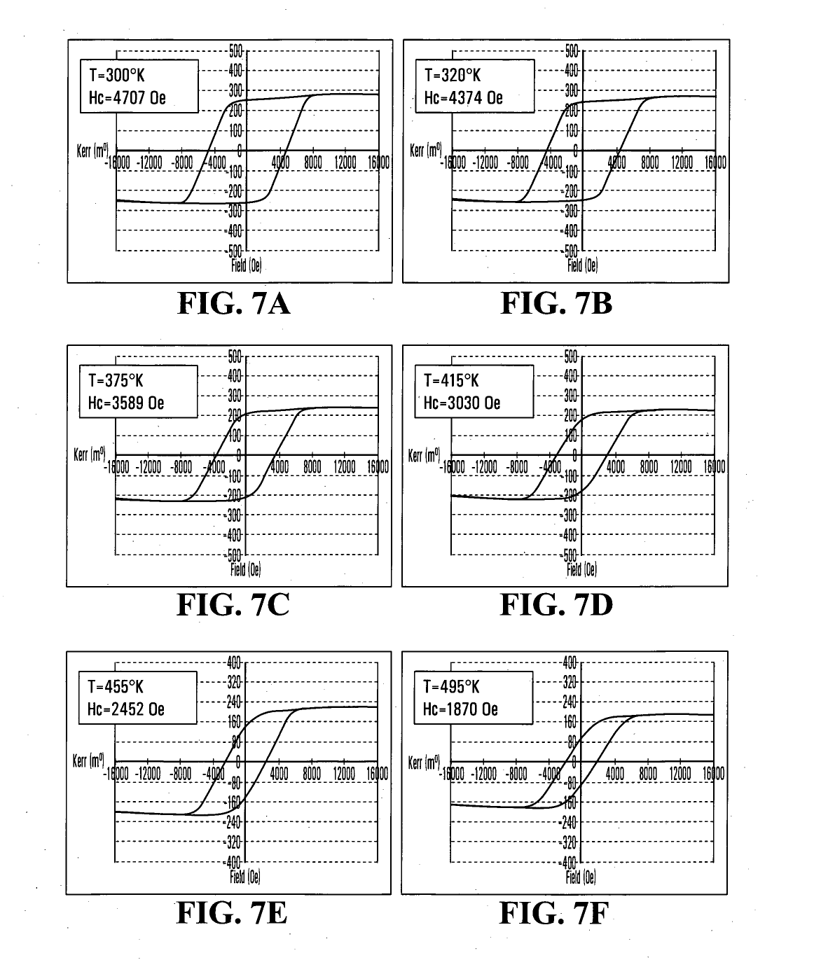

Using exemplary methods, the coercivity of a magnetic medium is measured at different temperature, as shown in FIGS. 7A-7F.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

1. An apparatus for testing a magnetic medium at multiple temperatures of interest, comprising:
a single light source to provide polarized light incident on a magnetic surface of said magnetic medium, said polarized light being capable of being reflected for measurement of the magneto-optical Kerr effect and of adjustment for heating said surface at a point of incidence to said multiple temperatures of interest;
a measuring subsystem to measure polarization of reflected light due to the magneto-optical Kerr effect, said reflected light reflected from said magnetic medium in response to said polarized light incident on said magnetic surface,
wherein said polarized light heats said magnetic surface where said polarized light is incident, to said multiple temperatures of interest, to allow determination of magnetic properties of said magnetic medium at said multiple temperatures of interest using the magneto-optical Kerr effect.

2. The apparatus of claim 1, wherein intensity of said polarized light is varied.

3. The apparatus of claim 1, wherein frequency of said polarized light is varied.

4. The apparatus of claim 1, w herein duration of applied polarized light is varied.

5. The apparatus of claim 1, further comprising a temperature sensor to sense a temperature of said predetermined spot, wherein the temperature sensor is configured to receive reflected light reflected from said magnetic medium in response to said incident light.

6. The apparatus of claim 5, wherein the temperature sensor is configured to detect power of said incident light or to receive infrared light emitted from said magnetic medium in response to said temperature.

7. The apparatus of claim 1, wherein said incident light is configured to both probe said Kerr effect and heat said magnetic medium.

8. The apparatus of claim 1, further comprising at least one lens configured to focus said incident light on said pre-determined spot on said magnetic surface, in which the lens is further configured to collimate said reflected light from said pre-determined sport on said magnetic surface.

9. The apparatus of claim 8, in which said at least one lens is a focusing lens.

10. The apparatus of claim 8, in which said at least one lens is a collimating lens.

11-34. (canceled)

35. A method of testing a magnetic medium at temperatures of interest, said method comprising:
focusing light from a single source of polarized light to be incident on a magnetic surface of said magnetic medium, said single source of polarized light providing light for both measuring the magneto-optical Kerr effect, and heating said magnetic medium to multiple temperatures of interest;
measuring polarization of reflected light due to the magneto-optical Kerr effect, said reflected light reflected from said magnetic medium as a result of said light where incident;
varying said light source to heat said magnetic material where incident to pre-defined temperatures, to allow determination of the magnetic properties of said magnetic medium using the magneto-optical Kerr effect at said pre-defined temperatures.

36. The method of claim 35, wherein intensity of said polarized light is varied.

37. The method of claim 35, wherein frequency of said polarized light is varied.

38. The method of claim 35, wherein said duration of applied polarized light is varied.

39. The method of claim 35, further comprising measuring temperature of said magnetic surface where said light is incident.

40. The method of claim 35, further comprising detecting power of said polarized light.

41. The method of claim 39, further comprising receiving infrared light emitted from said magnetic medium to detect said temperature of said magnetic surface where said polarized light is incident.

42. The method of claim 35, wherein said polarized light is configured to both probe said Kerr effect and heat said magnetic medium.

43. The method of claim 35, wherein said polarized light is focused on said magnetic surface using at least one lens.

44. The method of claim 35, further comprising collimating said reflected light from said magnetic surface.

45-59. (canceled)
